(19) United States
(12) Patent Application Publication
(10) Pub. No.: US 2011/0241434 A1
(43) Pub. Date: Oct. 6, 2011

(54) COMMUNICATION SYSTEM, COMMUNICATION APPARATUS, AND METHOD OF SUPPLYING ELECTRIC POWER

(75) Inventors: Tomokazu YUASA, Akishima-shi (JP); Hideki MIYAZATO, Yokohama-shi (JP)

(73) Assignee: KABUSHIKI KAISHA TOSHIBA, Tokyo (JP)

(21) Appl. No.: 13/069,202

(22) Filed: Mar. 22, 2011

(30) Foreign Application Priority Data
Mar. 31, 2010 (JP) 2010-084354

(51) Int. Cl. H02J 17/00

(52) U.S. Cl. 307/104

(57) ABSTRACT

According to one embodiment, a communication system including a first communication apparatus and a second communication apparatus is provided. The first communication apparatus includes: a connector which is connectable to a cable for electrical transmission; an electric power generator which generates electric power when the cable is connected to the connector; a first communication module which communicates, by using electric power, with the second communication apparatus for supplying and receiving electric power; and an electric power receiver which receives electric power transmitted from the second communication apparatus. The second communication apparatus includes: a second communication module which communicates with the first communication apparatus for supplying and receiving electric power; and an electric power transmitter which transmits electric power to the first communication apparatus based on a result of a communication between the first communication module and the second communication module.

### CROSS REFERENCE TO RELATED APPLICATION(S)

The application is based upon and claims the benefit of priority from Japanese Patent Application No. 2010-084354 filed on Mar. 31, 2010; the entire contents of which are incorporated herein by reference.

### FIELD

Embodiments described herein relate generally to a communication system, a communication apparatus, and a method of supplying electric power.

### BACKGROUND

According to the development of the communication technology, communication apparatuses which can supply electric power between connected apparatuses, and communication standards for such a supply have been proposed.

As an example of an apparatus which can supply electric power between apparatuses, a peripheral apparatus of a personal computer driven by a secondary battery has been proposed which prevents a disabled state due to insufficient charge of the secondary battery from occurring (see JP-A-2000-20176).

In the case where electric power is supplied between apparatuses, there are a host apparatus which is an apparatus for supplying the electric power, and a target apparatus which is an apparatus for receiving the supply of electric power. Usually, the target apparatus does not supply electric power to another apparatus, and exists as an apparatus which is dedicated to receive the supply of electric power.

According to the recent development of the communication technology, however, communication standards in which two apparatuses can be set arbitrarily respectively to the host apparatus and the target apparatus, and electric power can be bidirectionally supplied between the two apparatuses have been proposed (for example, Mobile High-definition Link (MHL)). In such a case, when one of the apparatuses supplies a current to the other apparatus without permission, there is a possibility that a failure is caused. In this case, therefore, it is preferred to perform negotiation for exchanging, for example, information indicative of whether electric power is to be supplied between the two apparatuses or not. In the proposed standards, the case where electric power can be bidirectionally supplied between two apparatuses is not particularly considered.

In the case where electric power can be bidirectionally supplied between two apparatuses, it is preferred to perform negotiation. However, when one of the apparatuses has no electric power (for example, a power supply is not connected, or the battery runs out), for example, the negotiation cannot be performed, and hence the supply of electric power cannot be started.

### BRIEF DESCRIPTION OF THE DRAWINGS

FIG. 1 is an overview showing an example of a communication system of a first embodiment.

FIG. 2 is a block diagram showing an example of a functional configuration of a part of an electric power supply function of the communication system of the first embodiment.

FIG. 3 is a sequence diagram showing an example of negotiation for supplying electric power in the first embodiment.

FIGS. 4A to 4E are conceptual diagrams showing an example of a procedure of, in the first embodiment, supplying electric power from a sink apparatus to a source apparatus in a state where electric power is not supplied to the source apparatus.

FIG. 5 is a sequence diagram showing an example of a process which, in the first embodiment, is performed by the sink and source apparatuses to supply electric power from the sink apparatus to the source apparatus in a state where electric power is not supplied.

FIG. 6 is a block diagram showing an example of a functional configuration of a part of an electric power supply function of a communication system of a second embodiment.

FIGS. 7A to 7E are conceptual diagrams showing an example of a procedure of, in the second embodiment, supplying electric power from a sink apparatus to a source apparatus in a state where electric power is not supplied to the source apparatus.

FIG. 8 is a sequence diagram showing an example of a process which, in the second embodiment, is performed by the sink and source apparatuses to supply electric power from the sink apparatus to the source apparatus in a state where electric power is not supplied.

### DETAILED DESCRIPTION

In general, according to one embodiment, a communication system including a first communication apparatus and a second communication apparatus is provided. The first communication apparatus includes: a connector which is connectable to a cable for electrical transmission; an electric power generator which generates electric power when the cable is connected to the connector; a first communication module which communicates, by using electric power, with the second communication apparatus for supplying and receiving electric power; and an electric power receiver which receives electric power transmitted from the second communication apparatus. The second communication apparatus includes: a second communication module which communicates with the first communication apparatus for supplying and receiving electric power; and an electric power transmitter which transmits electric power to the first communication apparatus based on a result of a communication between the first communication module and the second communication module.

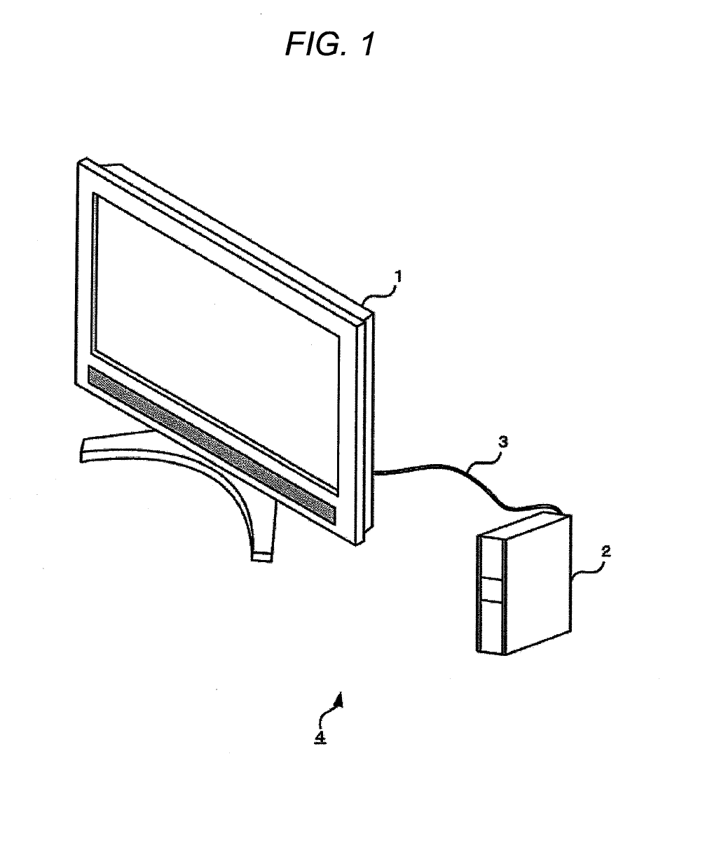

Hereinafter, embodiments will be described with reference to FIGS. 1 to 8.

### First Embodiment

A first embodiment will be described with reference to FIGS. 1 to 5.

FIG. 1 is an overview showing an example of a communication system 4 of the embodiment. In FIG. 1, a sink apparatus 1, a source apparatus 2, a connection cable 3, and the communication system 4 are shown.

In the embodiment, for example, the sink apparatus 1 is a digital television, and has a function of displaying a video contained in a received broadcast wave. The sink apparatus 1 can communicate with the source apparatus 2, and receive and replay video contents stored in the source apparatus 2. Moreover, a video contained in a broadcast wave can be stored as video contents in the source apparatus 2. Furthermore, the sink apparatus 1 can supply and receive electric power to and from the source apparatus 2 through the connection cable 3. In the embodiment, the case will be exemplarily described where, in an environment where the sink apparatus 1 is connected to, for example, an in-home outlet through which electric power can be supplied, and can transmit electric power to the source apparatus 2, the sink apparatus 1 supplies electric power to the source apparatus 2.

In the embodiment, the source apparatus 2 is a hard disk drive having, for example, a nonvolatile magnetic storage medium, and can communicate with the sink apparatus 1 through the connection cable 3. Based on a request from the sink apparatus 1, the source apparatus 2 can transmit data such as video contents to the sink apparatus 1. Moreover, the source apparatus 2 can store video contents transmitted from the sink apparatus 1, on the storage medium. Furthermore, the source apparatus 2 can supply and receive electric power to and from the sink apparatus 1 through the connection cable 3. In the embodiment, the case where the source apparatus 2 is not connected to, for example, an in-home outlet through which electric power can be supplied, and performs certain operations while being supplied with electric power from the sink apparatus 1 will be exemplarily described.

The connection cable 3 is a wire cable through which the sink apparatus 1 and the source apparatus 2 can be communicably connected to each other, and, in the embodiment, is for example a cable compliant with the Universal Serial Bus (USB) standard. The connection cable 3 has a line for data communication, and that for supplying electric power (for transmitting supplied electric power), so that communication, and transmission and reception of electric power between connected apparatuses are enabled.

The communication system 4 has the sink apparatus 1 and the source apparatus 2. In the communication system 4 of the embodiment, the sink apparatus 1 and the source apparatus 2 can mutually supply electric power. In the case where the source apparatus 2 is not connected to an outlet or the like and cannot be supplied with electric power from an outlet, for example, the source apparatus 2 can transmit a signal requesting a supply of electric power, to the sink apparatus 1. In response to the signal, the sink apparatus 1 transmits electric power to the source apparatus 2 through the connection cable 3. With using the received electric power, therefore, the source apparatus 2 can cause internal modules to operate. Conversely, in response to a request from the sink apparatus 1, the source apparatus 2 can supply electric power to the sink apparatus 1 in a procedure similar to that described above. The sink apparatus 1 and the source apparatus 2 can mutually supply electric power. When the electric power supply is to be performed, therefore, negotiation (communication for supplying and receiving electric power) may be performed before start of the electric power supply. In the communication system 4 of the embodiment, it is assumed that the sink apparatus 1 and the source apparatus 2 communicate with each other before supply and reception of electric power, to perform negotiation.

Next, the functional configuration related to the electric power supply in the communication system 4 will be described.

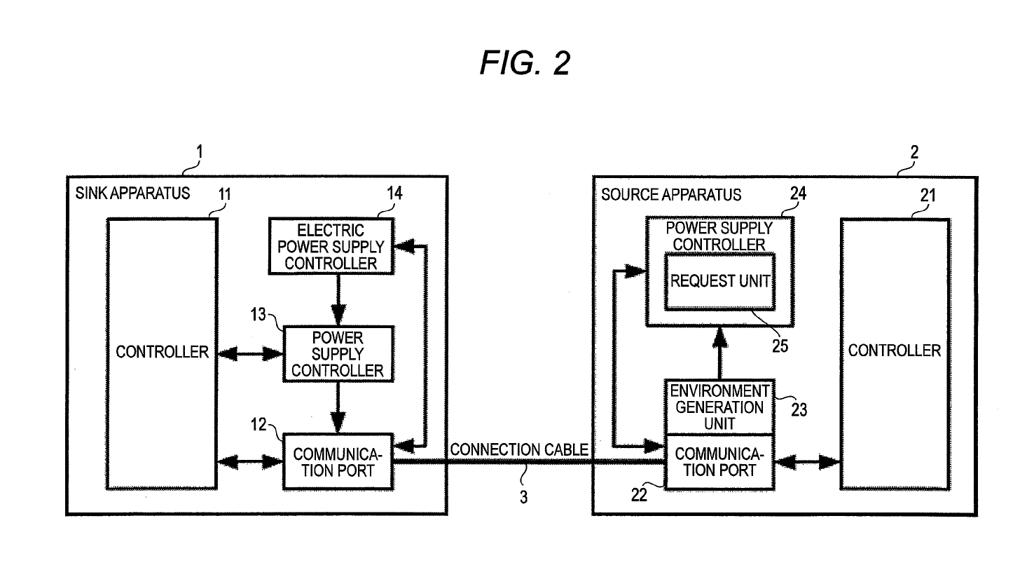

FIG. 2 is a block diagram showing an example of a functional configuration of a part of an electric power supply function of the communication system 4 of the embodiment.

First, the sink apparatus 1 has a controller 11, a communication port 12, a power supply controller 13, and an electric power supply controller 14.

The controller 11 has a function of controlling the whole sink apparatus 1. The hardware configuration of the controller 11 includes a Central Processing Unit ‘(CPU), a Read Only Memory (ROM), a Random Access Memory (RAM), etc. The CPU is a semiconductor chip which performs various calculation processes, the ROM is a nonvolatile memory which stores various programs to be executed by the CPU, and the like, and the RAM is a volatile memory which is used as a wok memory when the CPU performs a calculation process.

The communication port 12 is a port to which the connection cable 3 can be connected. In the embodiment, it is assumed that the communication port 12 is a port compliant with the USB standard.

The power supply controller 13 is connected to, for example, an outlet or the like which is outside the sink apparatus 1, and has a function of transmitting electric power received from the outlet or the like, to a certain configuration in the sink apparatus 1 including, for example, the controller 11 and the communication port 12.

The electric power supply controller 14 has a function of controlling the electric power supply to the source apparatus 2 through the connection cable 3. The electric power supply controller 14 has functions of, when the sink apparatus 1 and the source apparatus 2 are connected to each other through the connection cable 3, negotiating with the source apparatus 2 to determine whether electric power is to be supplied or not, and determining the value of the current to be supplied (transmitted) in this case.

Next, the source apparatus 2 has a controller 21, a communication port 22, an energy harvesting module (generator) 23, a power supply controller 24, and a request unit 25.

The controller 21 has a function of controlling the whole source apparatus 2, and has a function of performing a certain operation in accordance with a request from the sink apparatus 1 or the like.

The communication port 22 is a port to which the connection cable 3 can be connected. In the embodiment, it is assumed that the communication port 22 is a port compliant with the USB standard.

In the embodiment, the energy harvesting module (generator) 23 is a module which generates electric power through, for example, vibrations, and has function of, when the connection cable 3 is inserted into the communication port 22, generating electric power by using vibrations that are produced in the insertion. The energy harvesting module 23 supplies the generated electric power to the power supply controller 24.

The power supply controller 24 has a function of controlling the electric power supply which is performed on the sink apparatus 1 through the connection cable 3. The power supply controller 24 has functions of, when the sink apparatus 1 and the source apparatus 2 are connected to each other through the connection cable 3, negotiating with the sink apparatus 1 to determine whether electric power is to be supplied or not, and determining the value of the electric power to be supplied (transmitted) in this case. The power supply controller has a further function of, in the case where the source apparatus 2 requests the sink apparatus 1 to supply electric power, transmitting information indicating of the request and a desired current value.

The request unit 25 has a function of, when electric power is supplied from the energy harvesting module 23, transmitting a signal from the communication port 22 to the sink apparatus 1 through the connection cable 3. The signal which is transmitted from the request unit 25 will be described later.

Next, negotiation in the case where the electric power supply is to performed will be described.

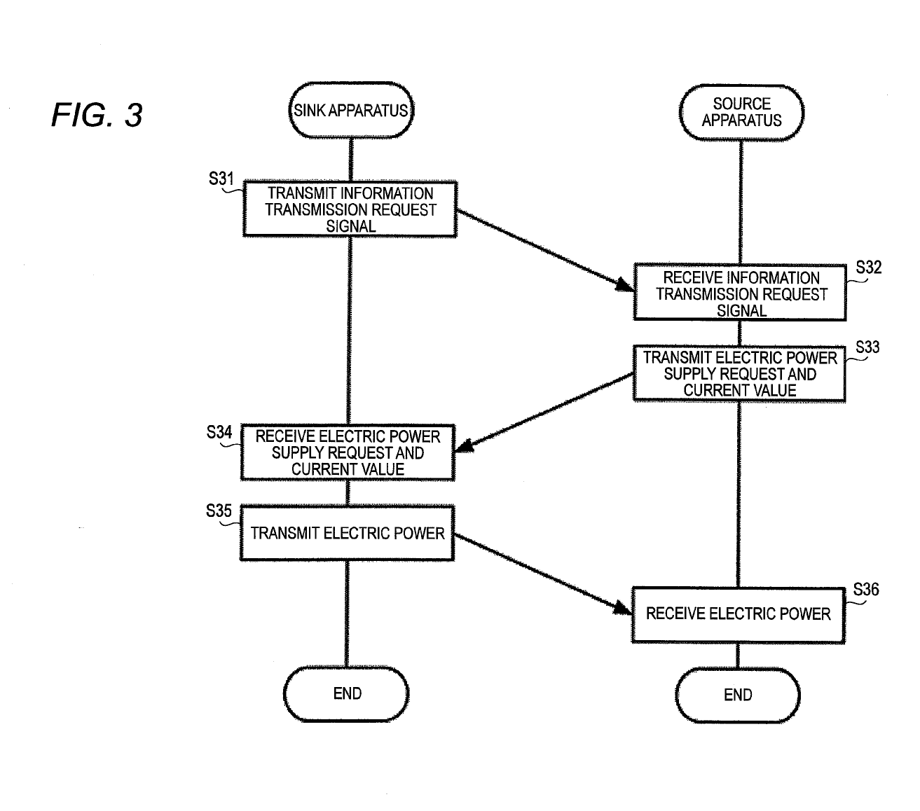

FIG. 3 is a sequence diagram showing an example of negotiation for the supply of electric power in the embodiment. Here, the contents of negotiation in the case where electric power is supplied from the sink apparatus 1 to the source apparatus 2 will be described.

First, the electric power supply controller 14 of the sink apparatus 1 transmits an information transmission request signal which is a signal requesting the source apparatus 2 to transmit information related to electric power supply (step S31).

The power supply controller 24 of the source apparatus 2 which receives the signal transmits to the sink apparatus 1 a signal indicative of information that the sink apparatus wishes to receive a supply of electric power (information requesting the sink apparatus 1 to transmit electric power), and, in the case where the sink apparatus wishes to receive a supply of electric power, information of the current value in the supply (steps S32 and S33).

Next, the electric power supply controller 14 of the sink apparatus 1 which receives the signal operates in the following manner in accordance with the signal. When information that an electric power supply is not necessary (information requesting the sink apparatus 1 not to supply electric power) is received from the source apparatus 2, the electric power supply controller 14 performs nothing. When the signal indicative of information that an electric power supply is to be received, and information of the current value in the supply is received (step S34), the electric power supply controller 14 instructs the power supply controller 13 to transmit electric power at the current value to the communication port 12. Based on the instructions, the power supply controller 13 transmits electric power to the source apparatus 2 through the communication port 12 (step S35). Therefore, the source apparatus 2 can receive the electric power transmitted from the sink apparatus 1 (step S36).

In an electric power supply between apparatuses which can mutually supply electric power, such as the sink apparatus 1 and the source apparatus 2, there is a case where negotiation such as described above is performed before the electric power supply. In the case where electric power is originally supplied to the source apparatus 2, negotiation can be performed. In the case where electric power is not supplied to the source apparatus 2, however, the source apparatus 2 cannot operate, and hence cannot transmit the signal in step S32 (the sink apparatus 1 cannot recognize the situation). Therefore, negotiation cannot be performed between the sink apparatus 1 and the source apparatus 2.

Next, the procedure of, in the embodiment, an electric power supply from the sink apparatus 1 to the source apparatus 2 in a state where electric power is not supplied to the source apparatus 2 will be described.

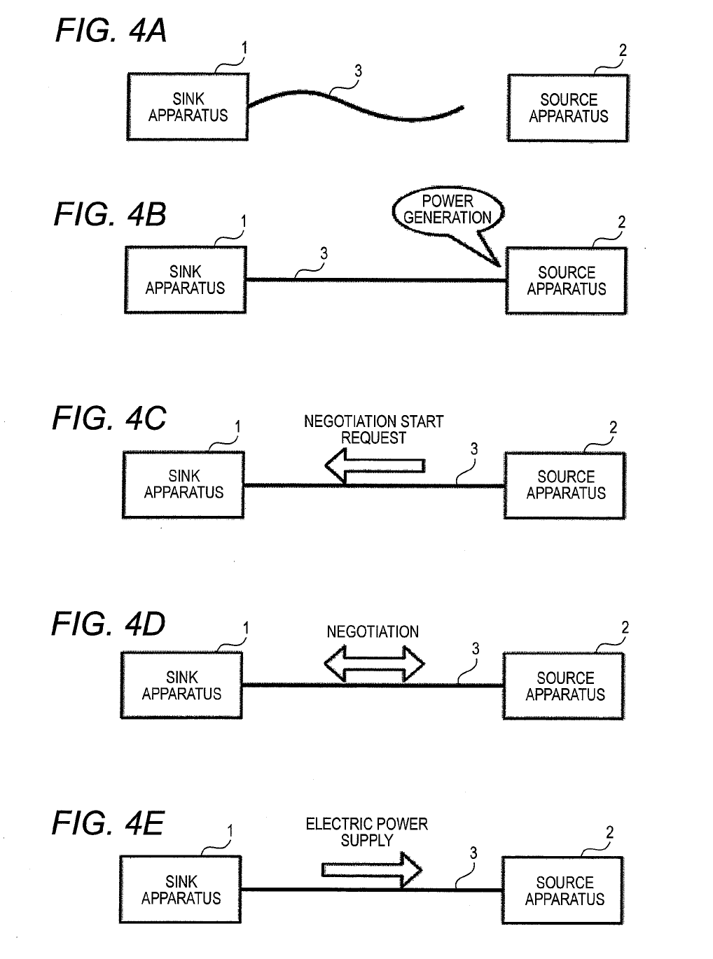

FIGS. 4A to 4E are conceptual diagrams showing an example of a procedure of, in the embodiment, supplying electric power from the sink apparatus 1 to the source apparatus 2 in a state where electric power is not supplied to the source apparatus 2.

First, the connection cable 3 is connected to the sink apparatus 1 (FIG. 4A).

Next, when the connection cable 3 is connected to the communication port 22 of the source apparatus 2, the energy harvesting module 23 of the source apparatus 2 generates electric power by using vibrations that are produced in the connection (FIG. 4B).

The energy harvesting module 23 supplies the generated electric power to the power supply controller 24, and the request unit 25 transmits a negotiation start request signal to the sink apparatus 1 by using the electric power (FIG. 4C). The negotiation start request signal is a signal which requests the sink apparatus to transmit the information transmission request signal in step S31 of FIG. 3 to the source apparatus 2.

Upon receiving the negotiation start request signal, the sink apparatus 1 transmits the information transmission request signal based on the negotiation start request signal, and starts negotiation with the source apparatus 2 (FIG. 4D). At this time, the electric power due to the generation in the energy harvesting module 23 is supplied to the power supply controller 24 of the source apparatus 2, and hence the power supply controller 24 can perform negotiation.

When the negotiation is ended, the sink apparatus 1 supplies electric power to the source apparatus 2 (FIG. 4E).

Next, the procedure will be described in detail.

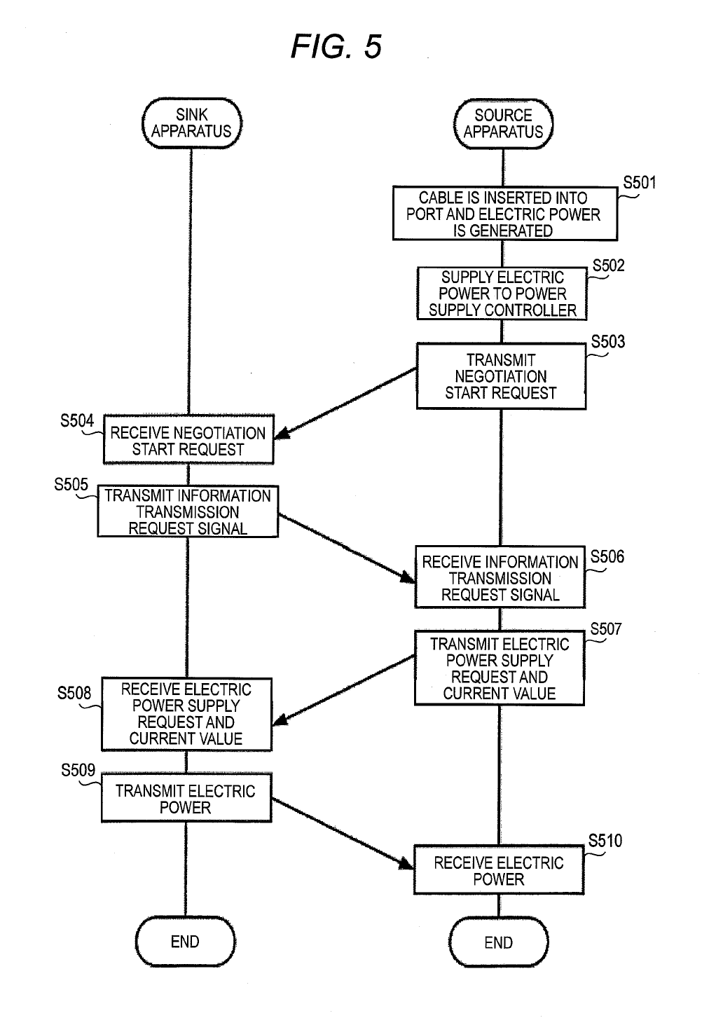

FIG. 5 is a sequence diagram showing an example of a process which, in the embodiment, is performed by the sink apparatus 1 and source apparatus 2 to supply electric power from the sink apparatus 1 to the source apparatus 2 in a state where electric power is not supplied.

First, when the connection cable 3 is inserted into the communication port 22 of the source apparatus 2, the energy harvesting module 23 generates electric power by using vibrations that are produced in the insertion (step S501), and supplies the electric power to the power supply controller 24 (step S502).

By using the supplied electric power, the request unit 25 of the power supply controller 24 transmits the negotiation start request signal to the sink apparatus 1 through the connection cable 3 (step S503).

When receiving the negotiation start request signal (step S504), the electric power supply controller 14 of the sink apparatus 1 transmits the information transmission request signal which requests transmission of information related to an electric power supply, to the source apparatus 2 (step S505).

Upon receiving the information transmission request signal (step S506), the power supply controller 24 transmits a signal indicating that an electric power supply is instructed, and that indicative of information of the current value requested in the supply (step S507).

When receiving the signal indicating that an electric power supply is instructed, and that indicative of information of the current value requested in the supply (step S508), the electric power supply controller 14 of the sink apparatus 1 instructs the power supply controller 13 to transmit electric power in accordance with the signals, and electric power is transmitted at the requested current value (step S509).

The source apparatus 2 receives the transmission (step S510), and the series of flows related to the electric power supply is ended.

In the embodiment, the energy harvesting module 23 may have a configuration which can store electric power, such as a capacitor. In this case, the electric power which is generated by insertion of the connection cable 3 can be temporarily stored, and used in future communication. In the case where the connection cable 3 is not connected first to the sink apparatus 1 but first to the source apparatus 2, even when the source apparatus 2 transmits the negotiation start request signal through the connection cable 3, the request does not reach the sink apparatus 1 during a period when the connection cable 3 is not connected to the sink apparatus 1, and the source apparatus cannot receive an electric power supply. When electric power is stored in a capacitor or the like, the request unit 25 may transmit a plurality of times the negotiation start request signal by using the stored electric power, during a period when the information transmission request signal is not received. According to the configuration, the certainty that negotiation can be performed is improved.

In the embodiment, when the connection cable 3 is inserted into the communication port 22, the energy harvesting module 23 generates electric power by using vibrations that are produced in the insertion. Therefore, the source apparatus 2 can perform communication for supplying electric power without causing the user to be conscious of the communication.

In the communication system 4 of the embodiment, the communication apparatuses can supply bidirectionally mutually electric power, and, even when electric power is not supplied to one of the apparatuses, it is possible to supply electric power.

### Second Embodiment

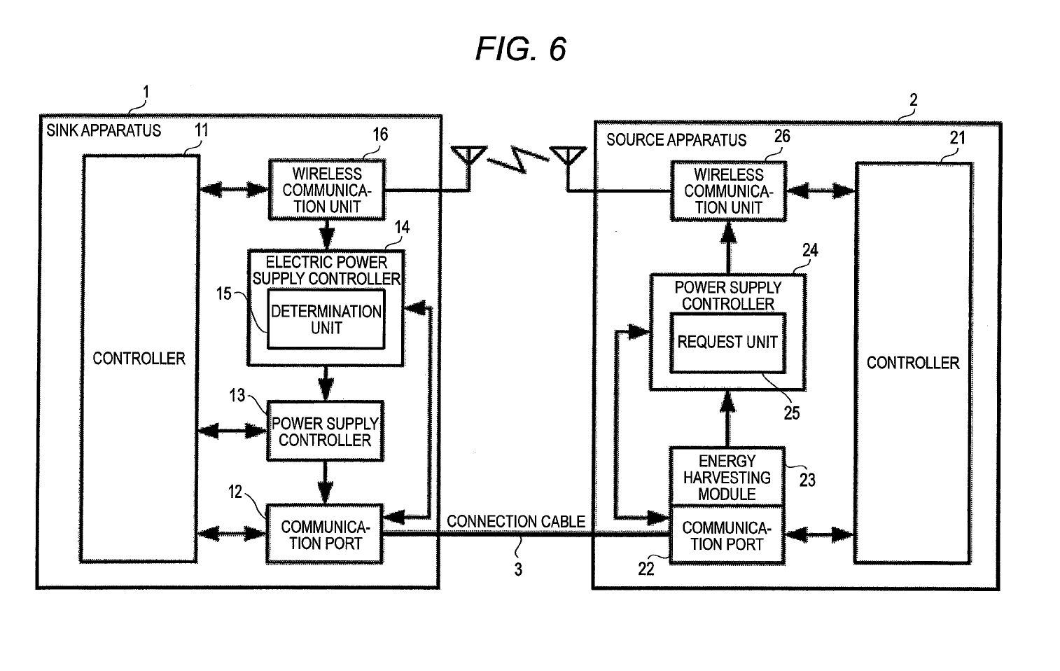

Next, a second embodiment will be described with reference to FIGS. 6 to 8. Hereinafter, configurations which have a function substantially similar to those of the first embodiment are designated by the same name and reference numeral as the first embodiment. The description which overlaps with similar description of the first embodiment will be omitted.

FIG. 6 is a block diagram showing an example of a functional configuration of a part of an electric power supply function of the communication system 4 of the embodiment.

In the embodiment, the sink apparatus 1 and the source apparatus 2 can wirelessly communicate with each other. In addition to the configuration of the first embodiment, a wireless communication unit 16 is disposed in the sink apparatus 1, and a wireless communication unit 26 in the source apparatus 2. It is assumed that the wireless communication units 16, 26 are wireless communication modules which can wirelessly communicate with each other, and which are compliant with, for example, the Bluetooth (registered trademark). However, the wireless communication modules in the embodiment are not restricted to this, and may be wireless communication modules which are compliant with another standard.

In the embodiment, the electric power supply controller 14 of the sink apparatus 1 has a determination unit 15. The determination unit 15 has a function of, when an external apparatus is connected to the communication port 12 through the connection cable 3, determining whether electric power is to be supplied to the apparatus or not.

In the embodiment, when electric power is supplied from the energy harvesting module 23 by connecting the connection cable 3 to the communication port 22, the request unit 25 of the source apparatus 2 transmits the negotiation start request signal by wireless communication through the wireless communication unit 26.

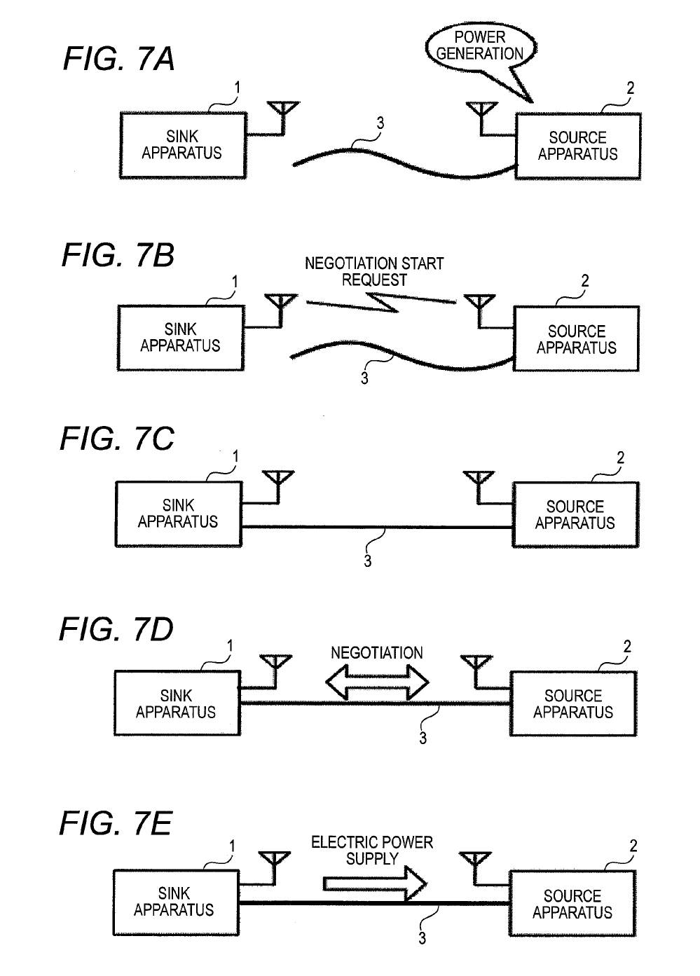

FIGS. 7A to 7E are conceptual diagrams showing an example of the procedure of, in the embodiment, supplying electric power from the sink apparatus 1 to the source apparatus 2 in a state where electric power is not supplied to the source apparatus 2.

Here, the case where the connection cable 3 is not connected first to the sink apparatus 1 but first to the source apparatus 2 will be considered. When the connection cable 3 is connected to the source apparatus, the source apparatus 2 is caused by the connection to generate electric power by the energy harvesting module 23 (FIG. 7A).

Next, the source apparatus 2 produces a negotiation start request by means of the electric power generated by the energy harvesting module 23, and transmits the request through the wireless communication unit 26 (FIG. 7B).

When, after the sink apparatus 1 receives the negotiation start request signal, the connection cable 3 is connected to the sink apparatus 1 (FIG. 7C), the sink apparatus 1 recognizes that the negotiation partner is the source apparatus 2, and starts to negotiate with the source apparatus 2 (FIG. 7D).

Finally, based on the contents of the negotiation, the sink apparatus 1 transmits electric power to the source apparatus 2, so that the source apparatus 2 is supplied with the electric power (FIG. 7E).

Next, the procedure will be described in detail.

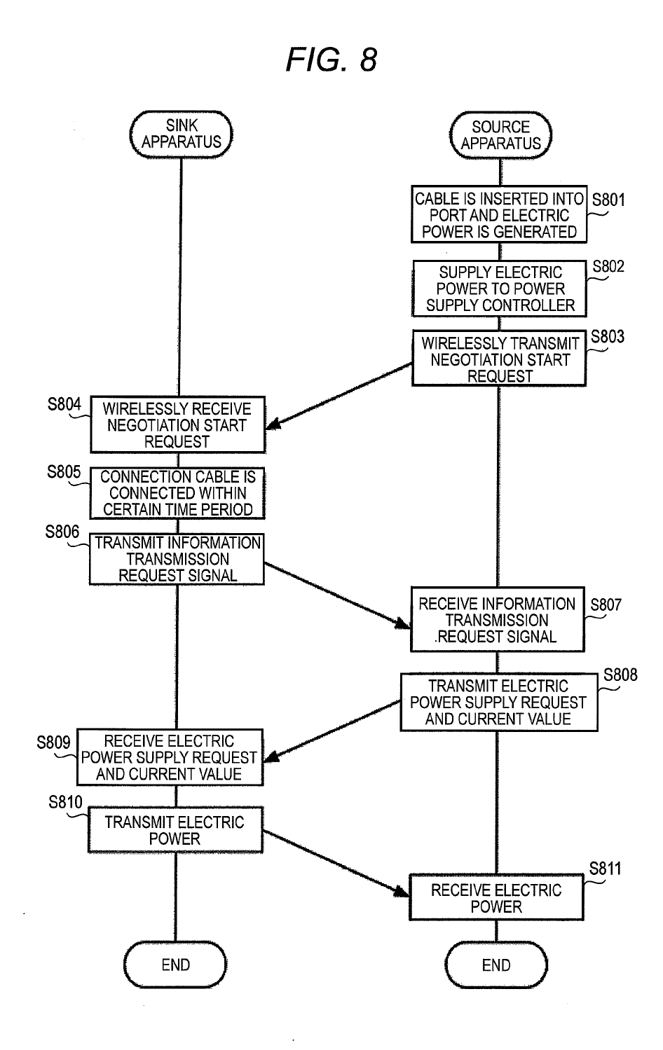

FIG. 8 is a sequence diagram showing an example of a process which, in the embodiment, is performed by the sink apparatus 1 and source apparatus 2 to supply electric power from the sink apparatus 1 to the source apparatus 2 in a state where electric power is not supplied.

First, when the connection cable 3 is connected to the communication port 22 of the source apparatus 2, the energy harvesting module 23 generates electric power by using vibrations that are produced in the connection (step S801), and supplies the electric power to the power supply controller 24 (step S802).

By using the supplied electric power, the request unit 25 of the power supply controller 24 transmits the negotiation start request signal to the sink apparatus 1 through the wireless communication unit 26 (step S803). At this time, the power supply controller 24 may transmit the negotiation start request signal, only through the wireless communication unit 26, or may in addition transmit the negotiation start request signal toward the connection cable 3 through the communication port 22.

When the electric power supply controller 14 of the sink apparatus 1 receives the negotiation start request signal (step S804), the determination unit 15 of the electric power supply controller 14 monitors the connection state of the communication port 12, and determines whether the connection cable 3 is connected to the communication port 12 within a certain time period or not. If the connection cable 3 is not connected within the certain time period, the electric power supply controller 14 performs nothing. If the determination unit 15 determines that the connection cable 3 is connected to the communication port 12 of the sink apparatus 1 within the certain time period, the electric power supply controller 14 transmits the information transmission request signal which requests transmission of information related to an electric power supply, to the source apparatus 2 (step S806).

Upon receiving the information transmission request signal (step S807), the power supply controller 24 of the source apparatus 2 transmits a signal indicating that an electric power supply is instructed, and that indicative of information of the current value requested in the supply (step S808).

When receiving the signal indicating that an electric power supply is instructed, and that indicative of information of the current value requested in the supply (step S809), the electric power supply controller 14 of the sink apparatus 1 instructs the power supply controller 13 to transmit electric power in accordance with the signals, and electric power is transmitted (step S810).

The source apparatus 2 receives the transmission (step S811), and the series of flows related to the electric power supply is ended.

In the embodiment, the source apparatus 2 transmits the negotiation start request signal through the wireless communication unit 26. Even when the connection cable 3 is not connected to the sink apparatus 1 in advance of connection to the source apparatus 2, therefore, the negotiation start request signal can be transmitted to the sink apparatus 1.

In the embodiments, the sink apparatus 1 and the source apparatus 2 are exemplarily used as communication apparatuses. The invention is not restricted to this. Various other modifications such as those using wireless communication apparatuses or mobile apparatuses may be possible.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system comprising: a first communication apparatus; and a second communication apparatus,
wherein the first communication apparatus comprises:
a connector configured to connect to a cable;
an electric power generator configured to generate first electric power for communication when the cable is connected to the connector;
a first communication module configured to communicate with the second communication apparatus with regards to information relating to supplying and receiving second electric power for driving the first communication module; and
an electric power receiver configured to receive the second electric power from the second communication apparatus, and
wherein the second communication apparatus comprises:
a second communication module configured to communicate with the first communication apparatus for supplying and receiving the second electric power; and
an electric power transmitter configured to transmit the second electric power to the first communication apparatus in response to a communication between the first communication module and the second communication module.

2. The system of claim 1,
wherein the first communication apparatus further comprises:
a first signal transmitter configured to transmit a first signal for starting the communication,
wherein the second communication apparatus further comprises:
a first signal receiver configured to receive the first signal, and,
wherein the first communication module is configured to start the communication with the second communication module in response to the first signal.

3. The system of claim 2,
wherein the second communication module further comprises:
a second signal transmitter configured to transmit a second signal for acquiring information indicative of whether to execute the supply and reception of the second electric power; and
wherein the first communication module further comprises:
a second signal receiver configured to receive the second signal; and
a third signal transmitter configured to transmit a third signal indicating the information when the second signal is received.

4. The system of claim 3,
wherein the second signal transmitter is configured to transmit information of a current value requested by the first communication apparatus during the supply and reception of the second electric power, and
wherein the electric power transmitter is configured to transmit the second electric power at the current value.

5. The system of claim 4, wherein
the electric power generator is configured to generate the first electric power through vibrations due to insertion of the cable into the connector.

6. The system of claim 2,
wherein the first signal transmitter is configured to wirelessly transmit the first signal, and
wherein the first signal receiver is configured to wirelessly receive the first signal.

7. The system of claim 6,
wherein the second communication module is configured to start the communication with a counterpart apparatus if the first signal is wirelessly received and the cable is confirmed to be connected via the cable.

8. The system of claim 6, wherein,
the second communication module is configured to start the communication with a counterpart apparatus when the cable is confirmed to be connected via the cable within a threshold time period after the first signal is wirelessly received.

9. A communication apparatus comprising:
a connector configured to connect to a cable for electrical transmission;
an electric power generator configured to generate first electric power when the cable is connected to the connector;
a communication module configured to perform, by using the first electric power, communication for supplying and receiving second electric power with a counterpart apparatus; and
an electric power receiver configured to receive the second electric power from the counterpart apparatus.

10. The apparatus of claim 9, wherein
the electric power generator is configured to generate the first electric power through vibrations due to insertion of the cable into the connector.

11. A method of supplying electric power from a second communication apparatus to a first communication apparatus, the method comprising:
generating first electric power for communication at the first communication apparatus, when a cable for electrical transmission is connected to the first communication apparatus,
communicating between the first communication apparatus and the second communication apparatus related to supplying and receiving second electric power for driving the first communication apparatus, using the first electric power, and,
supplying the second electric power from the second communication apparatus to the first communication apparatus in response to the communication.

12. The method of claim 11, further comprising:
transmitting a first signal from the first communication apparatus to the second communication apparatus,
receiving the first signal, and,
starting the communication between the first communication apparatus the second communication the second communication apparatus in response to the first signal.

13. The method of claim 12, further comprising:
transmitting a second signal indicative of whether to execute the supply and reception of second electric power;
receiving the second signal; and
transmitting a third signal indicating whether to execute the supply and reception of electric power in response to the second signal.

14. The method of claim 13, further comprising:
transmitting information of a current value requested by the first communication apparatus during the supply and reception of electric power; and
transmitting the second electric power at the current value.

15. The method of claim 14, further comprising:
generating the first electric power through vibrations due to insertion of the cable into the connector.

16. The method of claim 12, further comprising:
wirelessly transmitting the first signal, and
wirelessly receiving the first signal.

17. The method of claim 16, further comprising:
starting the communication with a counterpart apparatus if the first signal is wirelessly received and the cable is confirmed to be connected via the cable.

18. The method of claim 16, further comprising:
starting the communication with a counterpart apparatus when the cable is confirmed to be connected via the cable within a threshold time period after the first signal is wirelessly received.
